(19) United States
(12) Patent Application Publication
(10) Pub. No.: US 2013/0308047 A1
(43) Pub. Date: Nov. 21, 2013

(54) CAMERA MODULE AND METHOD OF ASSEMBLING CAMERA MODULE

(71) Applicants: CHUN-MING CHEN, Tu-Cheng (TW); DI WU, Shenzhen City (CN)

(72) Inventors: CHUN-MING CHEN, Tu-Cheng (TW); DI WU, Shenzhen City (CN)

(21) Appl. No.: 13/659,966

(22) Filed: Oct. 25, 2012

(30) Foreign Application Priority Data
May 17, 2012 (CN) 201210153315.0

(51) Int. Cl. H04N 5/225; B23P 11/00

(52) U.S. Cl. 348/374; 29/464; 348/E05.028

(57) ABSTRACT

The present disclosure relates to a camera module, which includes a holder, a lens module and an image sensor module. The holder has a receiving space defined through the holder. The lens module is placed in an upper section of the receiving space. The image sensor module has an image sensor, which is placed at a bottom section of the receiving space. The lens module has at least one lens with an alignment structure facing the image sensor. The alignment structure is positioned in a non-optical area of the image sensor module. The alignment structure has an alignment center aligned with an optical axis of the lens module and the alignment center is further aligned with an image sensing center of the image sensor. The present disclosure further provides a method for assembling the camera module.

### BACKGROUND

1. Technical Field

The disclosure relates to a camera module and a method of assembling the same, and particularly to a camera module assembled precisely.

2. Description of Related Art

As mobile devices are miniaturized and become multi-functional, components for communication functions, camera functions, and audio reproduction functions are being modularized and miniaturized. In particular, mobile devices such as mobile phones and PDAs include a camera function using a camera module.

Current camera modules generally include a lens for focusing incoming light onto an image sensor that detects an image and converts it into an electrical signal representation. It is important that the lens be aligned very accurately with respect to the light-sensitive surface in X, Y and Z-directions, wherein the Z-direction is defined as a direction perpendicular to the light-sensitive surface, and wherein the X, Y-directions are defined as mutually perpendicular, both the X-direction and the Y-direction extending parallel to the light-sensitive surface. In relation to the alignment in the Z-direction, it is important that the light-sensitive surface of the image sensor chip is positioned at the focal point of the lens, in order to obtain a sharp image.

It is desirable to develop camera modules with high-precision and a method of assembling camera modules with good quality and high yield.

### BRIEF DESCRIPTION OF THE DRAWINGS

The components in the drawings are not necessarily drawn to scale, the emphasis instead being placed upon clearly illustrating the principles of a camera module and a method of assembling the same. Moreover, in the drawings, like reference numerals designate corresponding parts throughout the several views.

FIG. 1 shows an exploded diagram of a camera module of the disclosure.

FIG. 2 is a cross-sectional diagram of the assembled camera module of the disclosure.

FIG. 3 shows a schematic diagram of a lens positioned closely to an image sensor of an image sensor module, and particularly shows an alignment structure of the lens located on a surface of the lens facing the image sensor.

FIG. 4 shows another alignment structure of the lens, in which the alignment structure is a concave ring.

FIG. 5 further shows another alignment structure of the lens, in which the alignment structure is a set of arcuate blocks.

FIG. 6 is a schematic How chart illustrating a method of assembling the camera module of the disclosure.

### DETAILED DESCRIPTION

Embodiments of the disclosure will be described with reference to the accompanying diagrams.

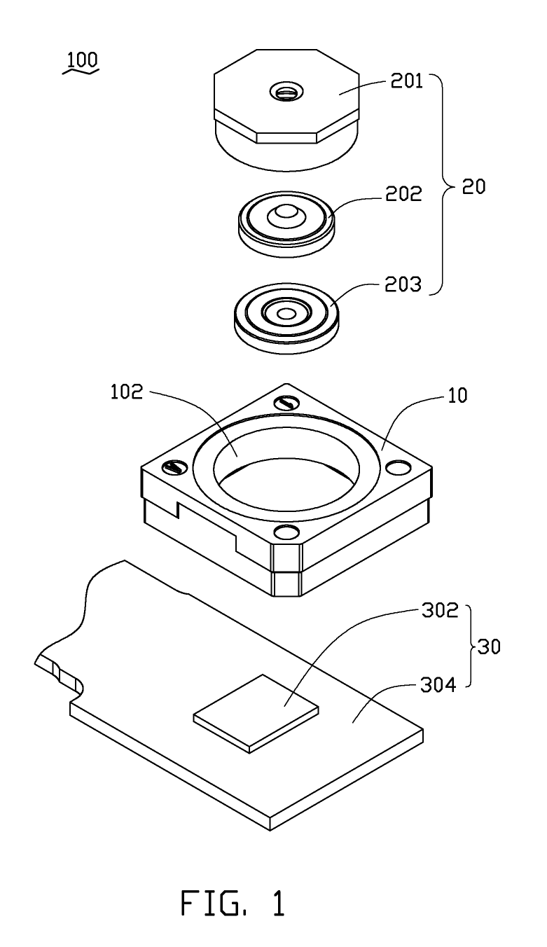

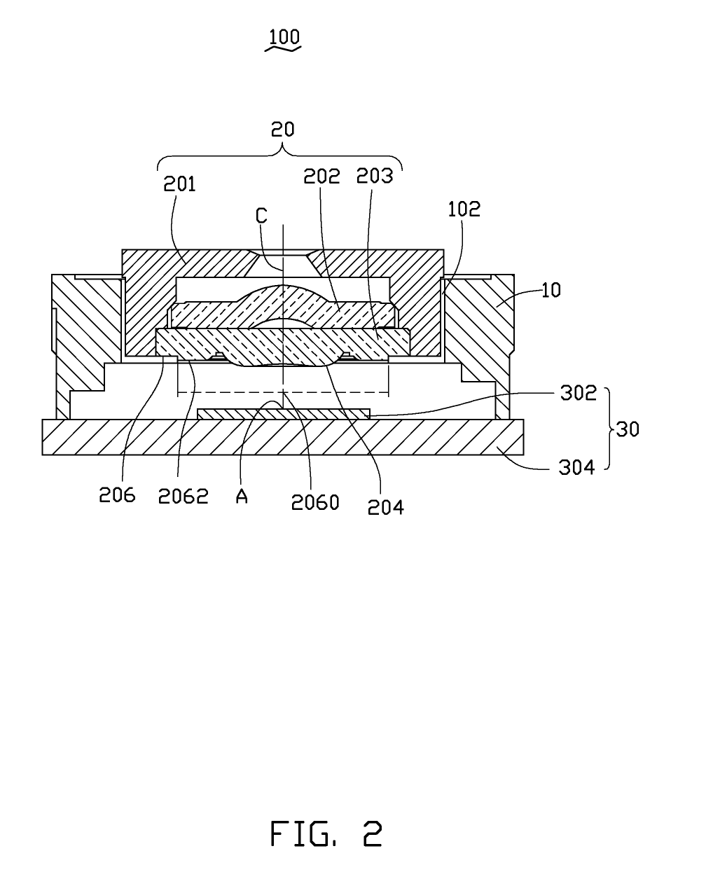

FIG. 1 shows an exploded diagram of a camera module 100 of the disclosure. The camera module 100 includes a holder 10, a lens module 20, and an image sensor module 30. The holder 10 is mounted on the image sensor module 30, and has a receiving space 102 defined through the holder 10. The lens module 20 is mounted on the holder 10 and engaged in an upper section of the receiving space 102 by screws, mortise and tenon, or lap joints. The image sensor module 30 has an image sensor 302 and a carrier 304. The bottom of the holder 10 is engaged with the carrier 304 and the image sensor 302 is placed in a bottom portion of the receiving space 102 enclosed by the holder 10 (see FIG. 2).

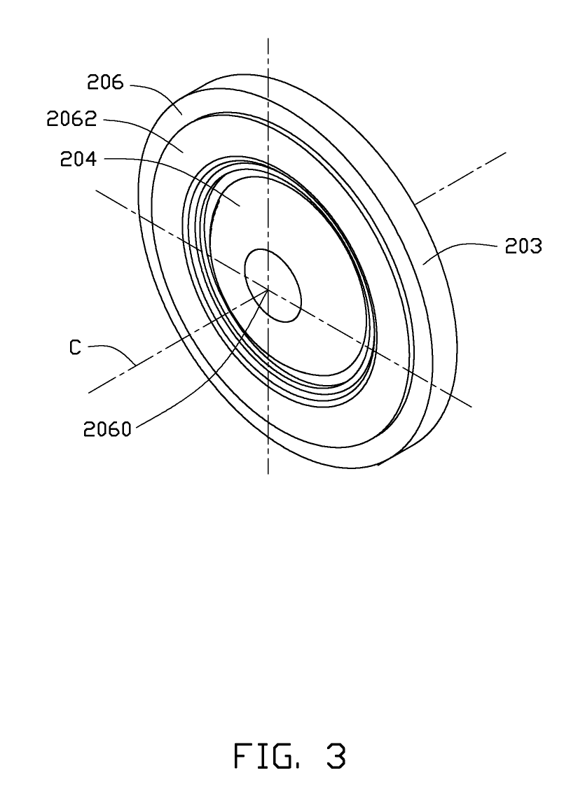

The lens module 20 and the image sensor 302 are engaged to the holder 10 at opposite ends. The lens module 20 has at least one lens and a barrel 201 to cover the at least one lens. For simplicity, two lenses, 202 and 203, are used in the present embodiment, and there may be one lens or more than one lens in the lens module 20. FIG. 3 shows a schematic diagram of the lens 203, and particularly shows a surface of the lens 203 facing the image sensor 302. Each of the lens 202, and 203 has an optical region 204 and a non-optical region 206 surrounding the optical region 204. The optical region 204 is a curved surface and receives incident light. The feature of the optical region 204 directly affects the performance of the lenses 202, and 203 and the lens module 20. In the present embodiment, the lens 203 is placed as close as possible to the image sensor 302 and has an alignment structure on a surface lacing the image sensor 302 in the non-optical region 206. The alignment structure of the present embodiment is a flange 2062 protruding from the surface facing the image sensor 302. The flange 2062 has a constant width and has an outer edge defining a circle. The center of the circle is an alignment center 2060 of the alignment structure. The alignment center 2060 is aligned with an optical axis C of the lens module 20.

The carrier 304 provides support and electrical connections for the image sensor 302. In the present embodiment, the carrier 304 is a circuit board and electrically connected to the image sensor 302. The image sensor 302 has a sensing surface receiving incident light through the lens module 20. The image sensor 302 further converts the incident light into electrical signals for further output. The sensing surface of the image sensor 302 has a square shape and a sensing center A located at an intersection of diagonal lines of the sensing surface. When the holder 10 and the lens module 20 are assembled onto the image sensor module 30, the optical axis C aligns with the sensing center A of the image sensor 302 in a Z-direction, in order to obtain the sharpest possible image.

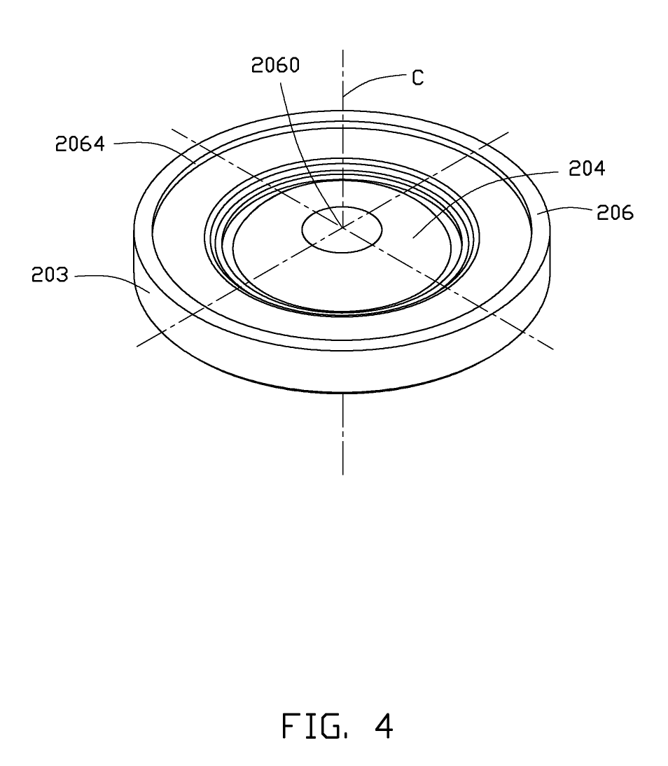

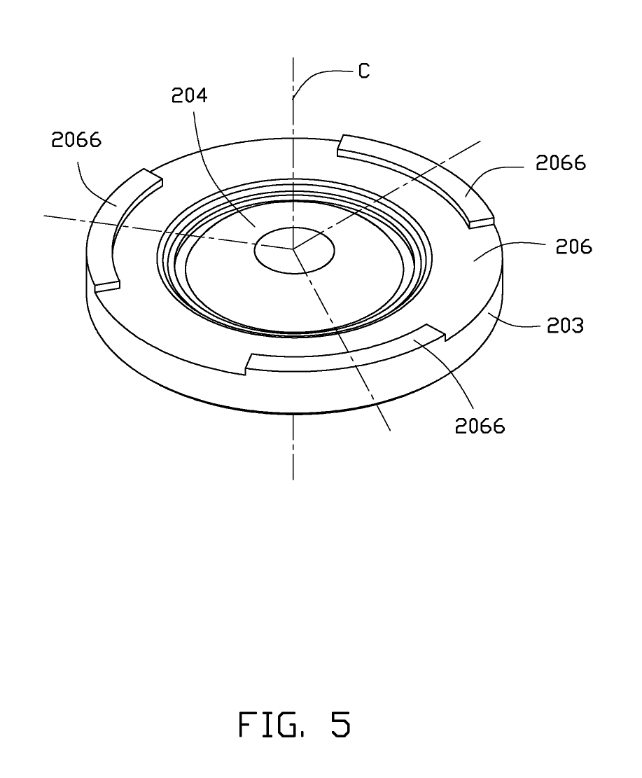

The alignment structure of the lens 203 of the lens module 20 may be modified to have other configurations. For instance, the alignment structure of the lens 203 may be a concave ring 2064 as shown in FIG. 4 or a set of arcuate blocks 2066 as shown in FIG. 5. As shown in FIG. 4, the concave ring 2064 is defined in the surface of the lens 203 lacing the image sensor 302 and placed in the non-optical region 206. The alignment center 2060 is defined by the outer edge or by the inner edge of the concave ting 2064 and is aligned with the optical axis C of the lens module 20. In addition, the alignment structure of the lens 203 shown in FIG. 5 includes at least three arcuate blocks 2066. The arcuate blocks 2066 are arranged in the non-optical region 206. A first, circle is defined by the inner edge of the arcuate blocks 2066 and a second circle is defined by the outer edge of the arcuate blocks 2066. The first circle and the second circle are concentric circles. Therefore, the center of the first circle and the center of the second circle are the same, and both point to the alignment center 2060. Since the lens 203 is a component of the lens module 20, the alignment center 2060 is aligned with the optical axis C of the lens module 20.

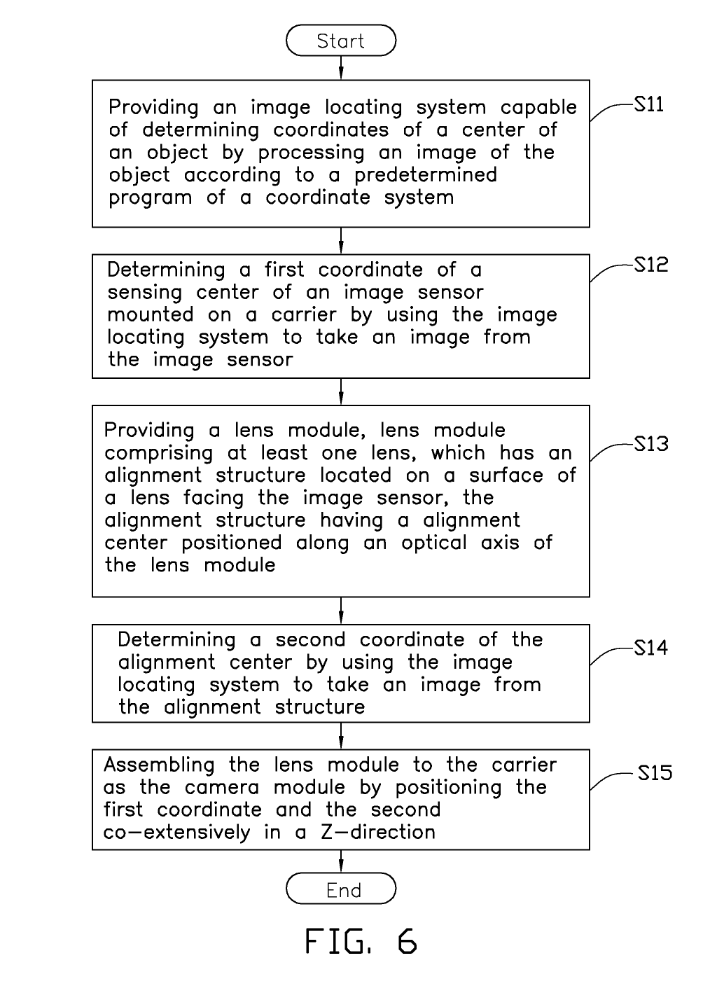

FIG. 6 is a schematic flow chart illustrating a method of assembling the camera module of the disclosure. The method includes steps S11-S15. Details of the method are illustrated in the following.

In step S11, an image locating system is provided. The image locating system takes images of an object and further processes the captured images to calculate coordinates of the center the object in the X-direction and in the Y-direction according to a predetermined program of a coordinate system. Hence, each object has its individual coordinate in the coordinate system.

In step S12, the image locating system captures an image of the image sensor 302 on the carrier 304, and particularly the image of the sensing surface of the image sensor 302, to calculate a first coordinate (X1, Y1) of the sensing center A of the sensing surface. Since the image sensor 302 of the disclosure is square, the sensing center A of the sensing surface is located at the intersection of the diagonal lines of the sensing surface.

In step S13, the lens module 20 of the disclosure is provided. The lens module 20 includes the lens 203 which has the alignment structure in the non-optical region 206 on the surface facing the image sensor. For example, the alignment structure is the flange 2060 as shown in FIG. 3, and it has the alignment center 2060 aligned with the optical axis C of the lens module 20. The alignment structure may be the concave ring 2064 shown in FIG. 4 or the arcuate blocks 2066 shown in FIG. 5.

In step 14, the image locating system captures images of the flange 2062 and determines a second coordinates (X2, Y2) of the alignment center 2060 through the coordinate program.

In step 15, in order to accurately assemble the lens module 20 above the image sensor 302, the first coordinates (X1, Y1) is aligned with the second coordinates (X2, Y2), where the sensing center A and the alignment center 2060 are co-extensive in the Z-direction. Accordingly, the lens module 20 is mounted on the holder 10 and further mounted on the carrier 304. The holder 10 is engaged with the carrier 304 by adhesive. Therefore, the lens module 20 is assembled to the carrier 304 as the camera module 100.

As described above, the method of the disclosure arranges the alignment center 2060 of the alignment structure on the lens 203 and the sensing center C along the optical axis C of the lens module 20. Therefore, the camera module of the disclosure is assembled in a very precise manner and the performance of the camera module is enhanced.

Although, the present disclosure has been specifically described on the basis of this exemplary embodiment, the disclosure is not to be construed as being limited thereto. Various changes or modifications may be made to the embodiment without departing from the scope and spirit of the disclosure.

What is claimed is:

1. A camera module, comprising:
a holder comprising a receiving space defined through the holder;
a lens module positioned in an upper section of the receiving space, the lens module comprising at least one lens; and
an image sensor module comprising an image sensor, the image sensor being positioned in a bottom section of the receiving space;
wherein the at least one lens comprises a alignment structure positioned in a non-optical region and feeing the image sensor, the alignment structure comprising an alignment center, the alignment center and an image sensing center of the image sensor being positioned along an optical axis of the lens module.

2. The camera module as claim 1, wherein the alignment structure is a flange protruding from a surface of the lens in the non-optical region, and the alignment center is the center of the flange.

3. The camera module as claim 1, wherein the alignment structure is a concave ring defined in a surface of the lens in the non-optical region, and the alignment center is the center of the concave ring.

4. The camera module as claim 1, wherein the alignment structure comprises at least three arcuate blocks protruding from a surface of the lens in the non-optical region, and an edge of the at least three arcuate blocks defines a circle, which has a center located at the same position as the alignment center.

5. The camera module as claim 1, wherein the image sensor module further comprises a carrier connected to a bottom surface of the holder, and the image sensor is mounted on and electrically connected to the carrier.

6. A method of assembling a camera module, comprising steps of:
providing an image locating system capable of determining coordinates of a center of an object by processing an image of the object according to a predetermined program;
determining a first coordinate of a sensing center of an image sensor mounted on a carrier by using the image locating system to take an image from the image sensor;
providing a lens module, the lens module comprises at least one lens, which has an alignment structure located on a surface of a lens feeing the image sensor, the alignment structure having an alignment center positioned along an optical axis of the lens module;
determining a second coordinate of the alignment center by using the image locating system to take an image from the alignment structure; and
assembling the lens module on the carrier by positioning the first coordinate and the second coordinate co-extensively in a Z-direction.

7. The method of claim 6, wherein the image locating system has a predetermined coordinating system in an X-direction and a Y-direction to determine the coordinates of the objective.

8. The method of claim 6, wherein the image sensor has a square sensing surface, and the sensing center of the image sensor is an intersect of diagonal lines of the sensing surface.

9. The method of claim 6, wherein the alignment structure comprises a flange.

10. The method of claim 6, wherein the alignment structure comprises a concave ring.

11. The method of claim 6, wherein the alignment structure comprises at least three arcuate blocks.

12. The method of claim 6, wherein the second coordinate of the alignment center is determined by calculating a center of a circle defined by an edge of the alignment structure.
